(19) United States
(12) Patent Application Publication
(10) Pub. No.: US 2025/0093658 A1
(43) Pub. Date: Mar. 20, 2025

(54) HEAD-MOUNTED DISPLAY

(71) Applicant: JVCKENWOOD CORPORATION, Yokohama-shi (JP)

(72) Inventors: Kazuhiro KURAMOTO, Yokohama-shi (JP); Takatsugu AIZAKI, Yokohama-shi (JP)

(21) Appl. No.: 18/884,384

(22) Filed: Sep. 13, 2024

(30) Foreign Application Priority Data
Sep. 15, 2023 (JP) 2023-149927
Sep. 11, 2024 (JP) 2024-157810

(51) Int. Cl. G02B 27/01

(52) U.S. Cl. CPC G02B 27/0172; G02B 2207/101

(57) ABSTRACT

A head-mounted display includes a combiner, a beam splitter, and a light-shielding unit. The combiner is configured to combine display light with an external scene in front of a user wearing the head-mounted display. The beam splitter is arranged between the combiner and an eye of the user, and is configured to reflect the display light toward the combiner, and to transmit the display light reflected by the combiner. The light-shielding unit shields external light that is to be reflected by the beam splitter and be directed toward the eye of the user.

### CROSS-REFERENCE TO RELATED APPLICATIONS

The present application is based upon and claims the benefit of priority from Japanese Patent Applications No. 2023-149927, filed on Sep. 15, 2023, and No. 2024-157810, filed on Sep. 11, 2024, the entire contents of which are incorporated herein by reference.

### BACKGROUND

JP 2021-92746 A discloses a head-mounted display that includes a combiner, a beam splitter, and a light-shielding unit. In the head-mounted display, the light-shielding unit is arranged below the beam splitter and is provided to obstruct a field of view obliquely downward in front.

In such a conventional head-mounted display, it is desired to further widen a user's field of vision. However, if the combiner is simply made larger, for example, unintended external light may enter from the combiner and may obstruct the user's field of view.

### SUMMARY

A head-mounted display according to an embodiment includes a combiner, a beam splitter, and a light-shielding unit. The combiner is configured to combine display light with an external scene in front of a user wearing the head-mounted display, and is provided to extend below a lower edge of an optical path of the display light entering the combiner. The beam splitter is arranged between the combiner and an eye of the user, and is configured to reflect the display light toward the combiner, and to transmit the display light reflected by the combiner. The light-shielding unit is configured to shield external light that is to be transmitted through the combiner, be reflected by the beam splitter, and be directed toward the eye of the user.

A head-mounted display according to another embodiment includes a combiner, a beam splitter, and a light-shielding unit. The combiner is configured to combine display light with an external scene in front of a user wearing the head-mounted display. The beam splitter is arranged between the combiner and an eye of the user, and is configured to reflect the display light toward the combiner, and to transmit the display light reflected by the combiner. A field of vision of the user includes a first visual field region that is visually recognized by the user through the combiner, and a second visual field region that is visually recognized, as a field of vision continuing to a lower side of the first visual field region, without passing through the combiner and with passing below the combiner. The light-shielding unit shields external light that is to enter from below the second visual field region, be reflected by the beam splitter, and be directed toward the eye of the user.

### BRIEF DESCRIPTION OF DRAWINGS

FIG. 1 is a perspective view illustrating an external appearance of a head-mounted display according to an embodiment.

FIG. 2 is a diagram illustrating a configuration of a part of the head-mounted display according to the embodiment.

FIG. 3 is a diagram illustrating functional blocks of the head-mounted display according to the embodiment.

FIG. 4 is a schematic diagram illustrating a configuration of an optical system of the head-mounted display according to the embodiment.

FIG. 5 is a diagram illustrating a configuration of a light-shielding unit for shielding external light to be reflected by a beam splitter in the embodiment.

FIG. 6 is a schematic diagram illustrating a configuration of an optical system of a head-mounted display according to a first modified example of the embodiment.

FIG. 7 is a schematic diagram illustrating a configuration of an optical system of a head-mounted display according to a second modified example of the embodiment.

### DETAILED DESCRIPTION

A head-mounted display according to an embodiment will be described in detail below with reference to the drawings. Note that the present disclosure is not limited to the following embodiment. In order to clarify the description, the following description and drawings are appropriately simplified.

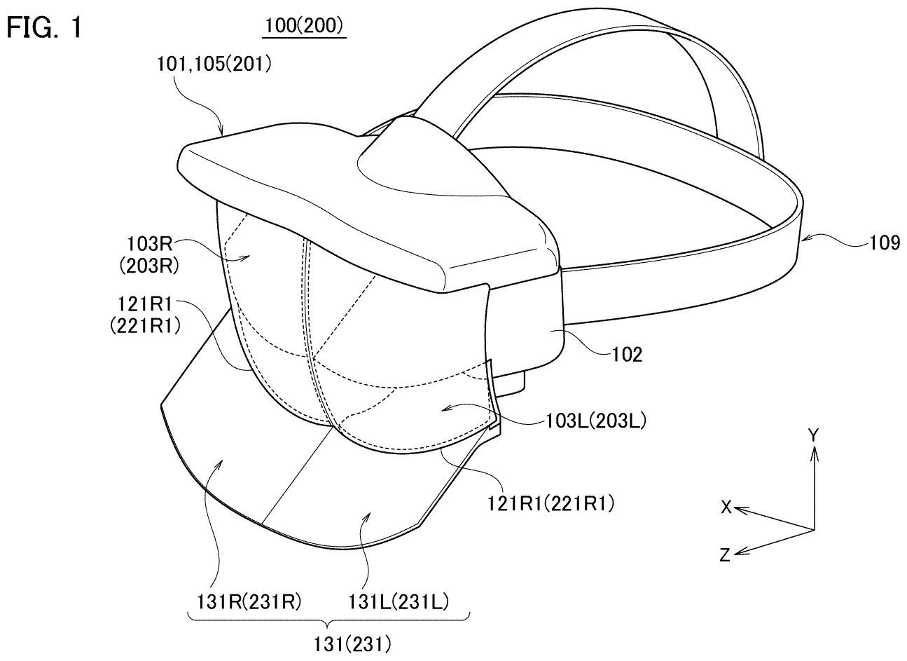

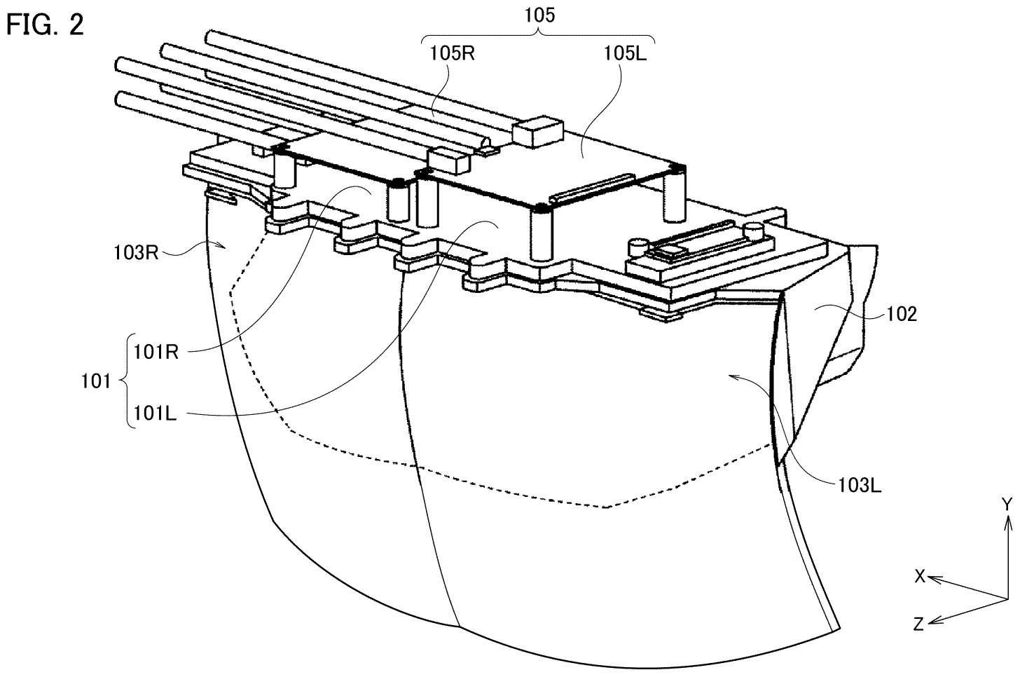

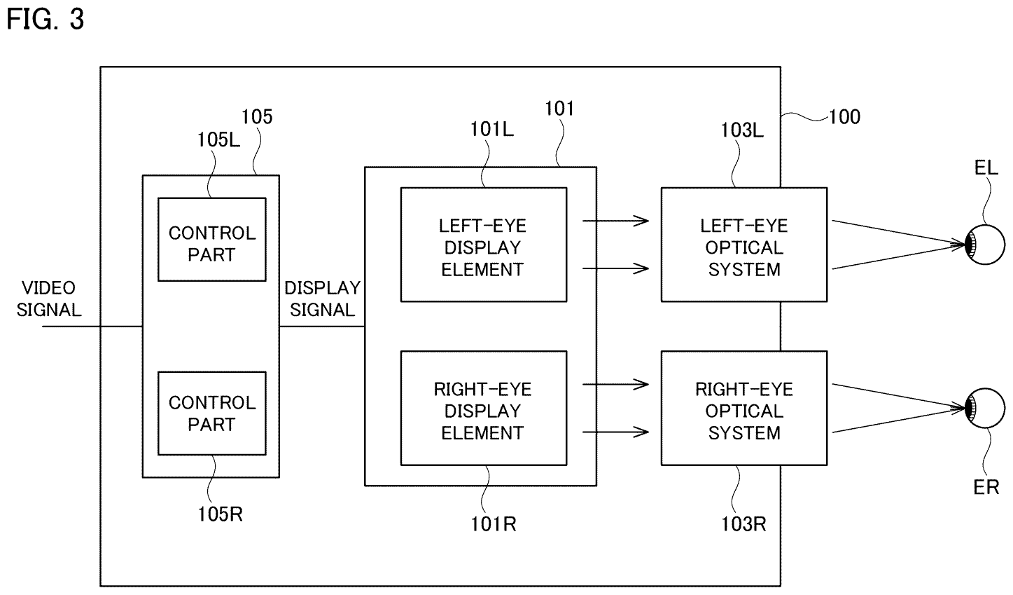

FIG. 1 is a schematic perspective view illustrating an external appearance of a head-mounted display 100. FIG. 2 is a diagram schematically illustrating a configuration of a part of the head-mounted display 100. FIG. 3 is a diagram illustrating functional blocks of a part of the head-mounted display 100. FIGS. 2 and 3 mainly illustrate a configuration related to image display by the head-mounted display 100. FIG. 2 illustrates an internal configuration of the head-mounted display 100, and in practice, components illustrated in FIG. 2 may be covered with a cover or the like.

The head-mounted display 100 is applicable to various applications, such as gaming, entertainment, industrial, medical, and flight simulator applications. The head-mounted display 100 is, for example, an AR (Augmented Reality) head-mounted display, or an MR (Mixed Reality) head-mounted display.

Hereinafter, for clarification, the description will be made using an XYZ three-dimensional Cartesian coordinate system. As seen from a user, a front-back direction (depth direction) is the Z direction, a left-right direction (horizontal direction) is the X direction, and an up-down direction (vertical direction) is the Y direction. The front direction is a +Z direction, the back direction is a −Z direction, the right direction is a +X direction, the left direction is a −X direction, the up direction is a +Y direction, and the down direction is a −Y direction.

A user, not illustrated in FIGS. 1 and 2, wears the head-mounted display 100. As illustrated in FIGS. 1 to 3, the head-mounted display 100 includes a display element unit 101, a frame 102, a left-eye optical system 103L, a right-eye optical system 103R, and a control unit 105. The control unit 105 includes a control part 105L and a control part 105R.

The frame 102 has a goggle shape or eyeglass shape, and is mounted on the head of the user by using a headband 109 or the like as illustrated in FIG. 1. As illustrated in FIG. 2, the display element unit 101, the left-eye optical system 103L, the right-eye optical system 103R, the control part 105L, and the control part 105R are attached to the frame 102. In FIGS. 1 to 3, the head-mounted display 100 is illustrated as a binocular type. Note that the head-mounted display 100 may have an eyeglass shape or be a monocular type.

As illustrated in FIG. 2, the display element unit 101 of the head-mounted display 100 includes a left-eye display element 101L and a right-eye display element 101R. The left-eye display element 101L generates a display image for a left eye. The right-eye display element 101R generates a display image for a right eye. Each of the left-eye display element 101L and the right-eye display element 101R includes a flat panel display, such as a liquid crystal monitor or an organic EL (Electro-Luminescence) monitor, as a display light emitting device. The shape of the display light emitting device included in each of the left-eye display element 101L and the right-eye display element 101R is not limited to a flat plate shape, and may be, for example, a curved surface shape. Each of the left-eye display element 101L and the right-eye display element 101R includes multiple pixels arranged in an array. Here, the array arrangement may be not only a two-dimensional matrix arrangement, but also a pantile arrangement or the like. The left-eye display element 101L is arranged on the left (−X side) of the right-eye display element 101R.

As illustrated in FIG. 2, the control unit 105 is provided above (on the +Y side of) the display element unit 101. As illustrated in FIGS. 2, 3, and the like, the control unit 105 is configured to be supplied with a video signal, a control signal, and a power source, from outside. The video signal and the like may be input to the control unit 105 through a wired connection, such as HDMI (registered trademark), or a wireless connection, such as Wi-Fi (registered trademark) or Bluetooth (registered trademark). The head-mounted display 100 may include a video generation unit (not illustrated) that generates a video signal. In this case, a video signal and the like generated by the video generation unit may be input to the control unit 105.

The control part 105L and the control part 105R include hardware resources, such as a CPU (Central Processing Unit) and a memory. The control part 105L and the control part 105R operate according to a computer program stored in the memory. Further, the control part 105L and the control part 105R each include a drive circuit or the like for the display light emitting device of the display element unit 101. As illustrated in FIG. 3, the control part 105L generates a display signal of a left-eye image on the basis of a video signal, a control signal, and the like supplied thereto, and outputs it to the left-eye display element 101L. Thus, the left-eye display element 101L outputs display light for displaying the left-eye image. The control part 105R generates a display signal of a right-eye image on the basis of a video signal, a control signal, and the like, and outputs it to the right-eye display element 101R. Thus, the right-eye display element 101R outputs display light for displaying the right-eye image. That is, the control unit 105 outputs display signals to the display element unit 101.

Note that the display element unit 101 is not limited to have the configuration where the left-eye display element 101L and the right-eye display element 101R illustrated in FIG. 2 are separate display elements, and may be configured as a single display element. That is, the single display element may generate a display image for a left eye and a display image for a right eye. In this case, the display element unit 101 generates a left-eye image using a part of one side of a display area of the display light emitting device of the display element unit 101, and generates a right-eye image using a part of the other side of the display area of the display light emitting device of the display element unit 101.

In the embodiment, a part or all of the display element unit 101, the control unit 105, and the like are not limited to a configuration where they are fixed to the frame 102. A part or all of the display element unit 101, the control unit 105, and the like may be detachably provided to the frame 102. For example, a part or all of the display element unit 101, the control unit 105, and the like may be a smartphone, a tablet computer, or the like that is detachably attached to the frame 102. In this case, an application program (application) for generating a display image for a head-mounted display may be installed in advance in the smartphone or the like.

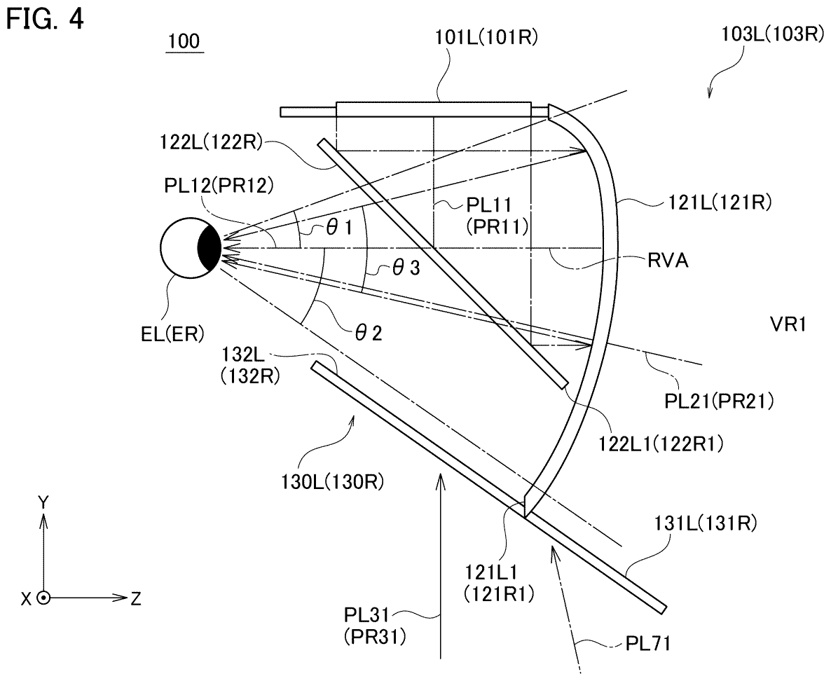

As illustrated in FIG. 3, the left-eye optical system 103L guides display light outputted by the left-eye display element 101L to a left eye EL of the user as a left-eye image. The right-eye optical system 103R guides display light outputted by the right-eye display element 101R to a right eye ER of the user as a right-eye image. The left-eye optical system 103L is arranged on the left (−X side) of the right-eye optical system 103R. As illustrated in FIG. 4, the left-eye optical system 103L is arranged in front (+Z direction) of the left eye EL of the user. Similarly, the right-eye optical system 103R is arranged in front (+Z direction) of the right eye ER of the user. The user can visually recognize a virtual image of a display image generated by the display element unit 101 in the front (+Z direction).

The head-mounted display 100 according to the embodiment is a semi-transmissive type. Thus, as illustrated in FIG. 4, the left-eye optical system 103L and the right-eye optical system 103R include combiners 121L and 121R to be described later, respectively. In the head-mounted display 100, which is the semi-transmissive type, display light from the display element unit 101, and an external scene that is transmitted light which is transmitted through the combiners 121L and 121R, enter the left eye EL and the right eye ER. Thus, the user can visually recognize a superimposed image where a display image is superimposed on scenery in the front (+Z direction).

An example of the left-eye optical system 103L and the right-eye optical system 103R (which are collectively referred to simply as “optical system” below) will be further described below. FIG. 4 is a schematic diagram illustrating a configuration of the optical system 103L (103R). Specifically, FIG. 4 is a schematic diagram illustrating a cross-sectional surface perpendicular to the left-right direction (X direction) of the head-mounted display 100, which includes a position in the left-right direction (X direction) where the left eye EL (right eye ER) of the user is located. Note that the left-eye optical system 103L and the right-eye optical system 103R are arranged symmetrically and have the same configuration. Thus, a detailed description of each element of the right-eye optical system 103R is omitted here, and reference numerals of respective elements are appended in parentheses after reference numerals of corresponding elements of the left-eye optical system 103L. In the following description, the left-eye optical system 103L in FIG. 4 will be described.

The left-eye optical system 103L includes the combiner 121L, a beam splitter 122L, and a light-shielding unit 130L. The combiner 121L, the beam splitter 122L, and the light-shielding unit 130L are fixed to the frame 102 illustrated in FIGS. 1 and 2.

The combiner 121L is a beam splitter, such as a half mirror, and reflects a part of incident light and transmits the remaining part thereof. If the percentage of reflection and the percentage of transmission of the combiner 121L are equal, the combiner 121L transmits approximately half of the amount of incident light, and reflects the remaining half.

Similarly, the beam splitter 122L is a beam splitter, such as a half mirror, and reflects a part of incident light and transmits the remaining part thereof. If the percentage of reflection and the percentage of transmission in the beam splitter 122L are equal, the beam splitter 122L transmits approximately half of the amount of incident light, and reflects the remaining half.

Note that the combiner 121L and the beam splitter 122L may have the percentage of reflection increased and the percentage of transmission decreased, or have the percentage of reflection decreased and the percentage of transmission increased.

The combiner 121L, which is a beam splitter, such as a half mirror, is a concave mirror. The beam splitter 122L is a plane mirror.

The combiner 121L and the beam splitter 122L are arranged in front (+Z direction) of the left eye EL of the user. The combiner 121L is arranged ahead (+Z direction) of the beam splitter 122L. In other words, the beam splitter 122L is arranged between the combiner 121L and the left eye EL of the user.

In the embodiment, the combiner 121L extends below a lower edge 122L1 of the beam splitter 122L in the up-down direction (Y direction) with respect to the eye of the user wearing the head-mounted display 100 (left eye EL in FIG. 4). In other words, the lower edge 121L1 of the combiner 121L is positioned below (on the −Y direction side of) the lower edge 122L1 of the beam splitter 122L in the up-down direction (Y direction).

The left-eye display element 101L is arranged above the beam splitter 122L (in the +Y direction). The left-eye display element 101L emits display light PL11 for forming a display image. That is, the left-eye display element 101L is arranged obliquely upward in front of the left eye EL.

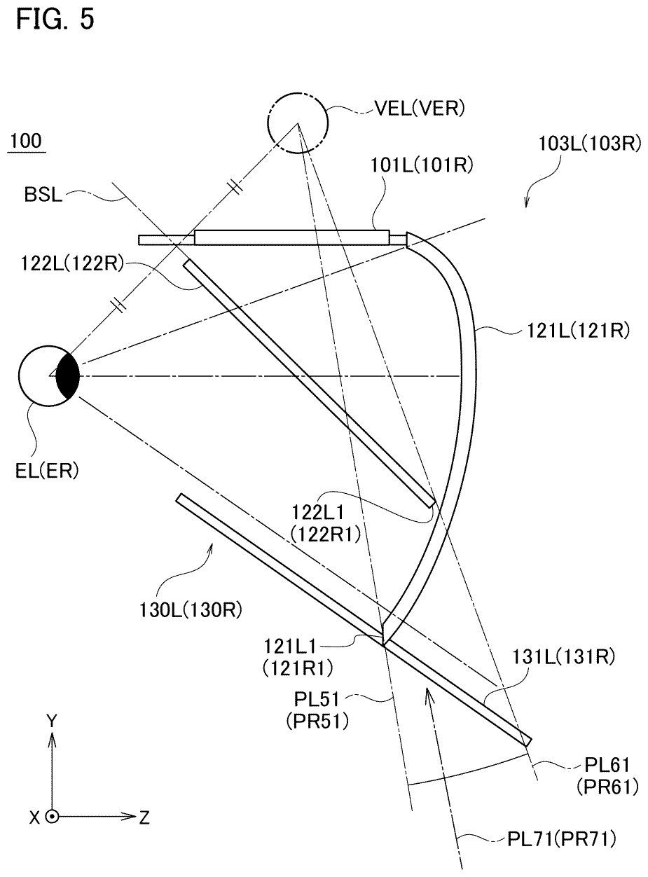

As illustrated in FIGS. 4 and 5, the light-shielding unit 130L is configured to shield at least external light PL71 that is to be transmitted through the combiner 121L, be reflected by the beam splitter 122L, and be directed toward the left eye EL.

In the embodiment, as illustrated in FIGS. 1 and 4, the light-shielding unit 130L is arranged below the left eye EL (in the −Y direction) in the up-down direction (the Y direction). The light-shielding unit 130 includes a light-shielding plate 131L and a light-shielding plate 132L.

The light-shielding plate 131L projects from the lower edge 121L1 of the combiner 121L forward (in the +Z direction) so as to be away from the user. The light-shielding plate 131L projects forward (in the +Z direction) while tilting downward (in the −Y direction) from the lower edge 121L1 of the combiner 121L of the left-eye optical system 103L. It is sufficient that the light-shielding plate 131L is made of a material that does not transmit light. The light-shielding plate 131L may be made of an elastic member, such as a resin material or elastic rubber, for example.

The light-shielding plate 132L is coupled to a rear end (end part in the −Z direction) of the light-shielding plate 131L, and is arranged below the left eye EL (in the −Y direction) in the up-down direction (in the Y direction). The light-shielding plate 132L extends from the lower vicinity of the left eye EL (in the −Y direction) (that is, from right below an upper edge of the beam splitter 122L) to the lower edge 121L1 of the combiner 121L in the front-back direction (in the Z direction). It is sufficient that the light-shielding plate 132L is made of a material that does not transmit light. The light-shielding plate 132L may be made of an elastic member, such as a resin material or elastic rubber, for example.

With this configuration, the light-shielding unit 130L shields the external light PL71 which is to be transmitted through the combiner 121L, and external light PL31 which is to enter the beam splitter 122L from below (the −Y side), be reflected by the beam splitter 122L, and be directed toward the left eye EL. The light-shielding unit 130L is formed, for example, with a light-shielding member having, at least on its inner surface, a black surface that absorbs light.

The light-shielding unit 130L may include one light-shielding plate where the light-shielding plate 131L and the light-shielding plate 132L are formed as one body. In such a structure, the light-shielding plate forming the light-shielding unit 130L may be provided to extend forward (in the +Z direction) while tilting downward (in the −Y direction) from one end edge on the user side in the lower vicinity of the left eye EL (in the −Y direction), as illustrated in FIGS. 4 and 5. The light-shielding plate forming the light-shielding unit 130L may be curved in such a manner that its upper surface is concave. As described above, the light-shielding unit 130L is provided to obstruct the field of view obliquely downward in front of the left eye EL.

In the head-mounted display 100 according to the embodiment, a viewing angle, in the up-down direction, of an external scene visually recognized by the user is asymmetric. Specifically, in a cross-sectional surface perpendicular to the left-right direction (X direction) including the eye (left eye EL in FIG. 4) of the user wearing the head-mounted display 100, the front-back direction (Z direction) at a position of the left eye EL in the up-down direction (position in the Y direction) is set as a reference line RVA. Here, the light-shielding unit 130L is fixed to the frame 102 in such a manner that a viewing angle θ2 obliquely downward in front with respect to the reference line RVA is larger than a viewing angle θ1 obliquely upward in front with respect to the reference line RVA.

As described above, the lower edge 121L1 of the combiner 121L extends below the lower edge 122L1 of the beam splitter 122L. Thus, in the head-mounted display 100, the user's field of vision is extended such that an external scene extends below (−Y direction) an angle of view θ3 of display light PL12.

Note that the viewing angle θ1 is formed by the reference line RVA and external light PL 21 which is transmitted through the vicinity of an upper edge of the combiner 121L. The viewing angle θ2 is formed by the reference line RVA and external light PL 21 which is transmitted through the vicinity of the lower edge 121L1 of the combiner 121L. The angle of view θ3 is formed by the display light PL12 which is generated by the display light PL11 emitted from one end edge (−Z direction) of the left-eye display element 101L and the display light PL 12 which is generated by the display light PL11 emitted from the other end edge (+Z direction) of the left-eye display element 101L.

In the embodiment, the lower edge 121L1 of the combiner 121L extends below the lower edge 122L1 of the beam splitter 122L. However, the structure of the combiner is not limited to this.

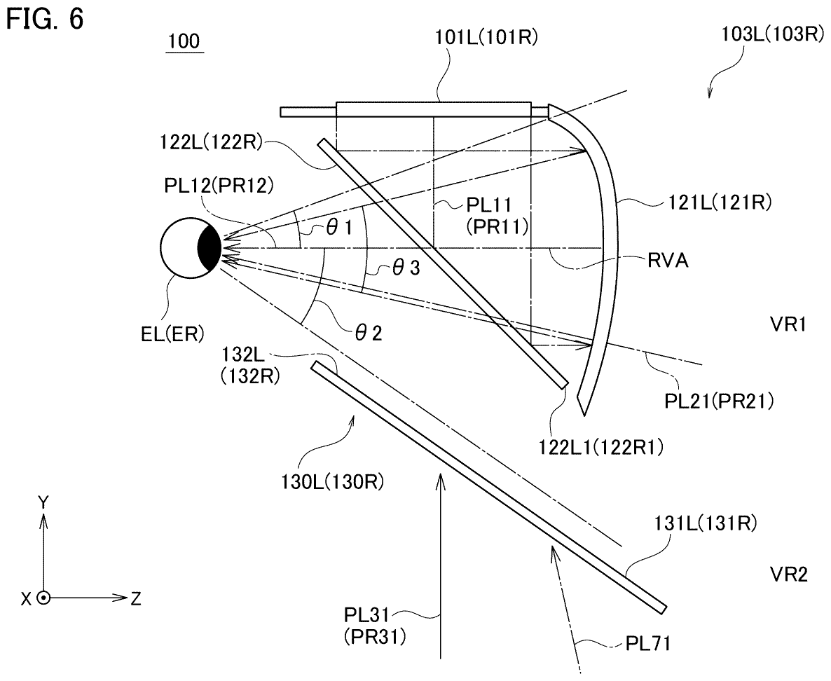

As a first modified example of the embodiment, for example, as illustrated in FIG. 6, the position of the lower edge of the combiner 121L in the up-down direction (Y direction) may be at the same position as, or may be slightly lower than, the lower edge 122L1 of the beam splitter 122L. Here, the structure of the light-shielding unit 130L in the first modified example may be the same as that of the light-shielding unit 130L illustrated in FIGS. 1 and 5. That is, the light-shielding unit 130L may be arranged below an optical path of the display light PL12, which is reflected by the combiner 121L and is directed toward the left eye EL, and a part of the light-shielding unit 130L may project from below (the −Y direction) a position of the lower edge of the combiner 121L in the front-back direction (Z direction) to a direction (+Z direction) away from the user. Note that the light-shielding plate 131L in the first modified example may project forward (in the +Z direction) while tilting downward (in the −Y direction), in a similar manner to the light-shielding plate 131L illustrated in FIGS. 1 and 5.

The user's field of vision in the head-mounted display 100 according to the embodiment is only a first visual field region VR1 where the external scene is visually recognized through the combiner 121L. The light-shielding plate 131L in the embodiment is arranged at a position not to enter the first visual field region VR1.

In contrast, the user's field of vision in the head-mounted display according to the first modified example includes the first visual field region VR1 where the external scene is visually recognized through the combiner, and a second visual field region VR2 where the external scene is visually recognized, as a field of vision continuing to the lower side (−Y side) of the first visual field region VR1, without passing through the combiner and with passing below the combiner. The light-shielding plate 131L in the first modified example is arranged at a position not to enter the first visual field region VR1 and the second visual field region VR2.

The light-shielding plate 131L of the light-shielding unit 130L in the first modified example shields the external light PL71 which is to enter from below (in the −Y direction) the second visual field region VR2, be reflected by the beam splitter 122L, and be directed toward the left eye EL of the user.

In the structure of the head-mounted display according to the first modified example, the user's field of vision is extended such that the external scene extends below (in the −Y direction) the angle of view θ3 of the display light PL12.

In the light-shielding unit 130L in each of the embodiment and the first modified example, it is sufficient that the external light PL31 is shielded, which is to enter from below (on the −Y side), be reflected by the beam splitter 122L, and be directed toward the left eye E. Thus, the light-shielding unit 130L may be provided with a lower window, to obtain a field of view obliquely downward in front, where a louver is arranged to transmit external light directly directed toward the left eye EL from below (on the −Y side) and to absorb light directed in other directions.

Further, in the embodiment, the light-shielding plate 131L may be formed with the light-shielding plate 132L as one body in the light-shielding unit 130L, but the embodiment is not limited to this. The light-shielding plate 131L may be formed separately from the light-shielding plate 132L in the light-shielding unit 130L, and may be coupled to the light-shielding plate 132L at the lower edge 121L1 of the combiner 121L.

The display light PL11 from the left-eye display element 101L will be described below. A display surface of the left-eye display element 101L faces downward (in the −Y direction). Thus, the display light PL11 from the left-eye display element 101L is emitted downward (in the −Y direction). The beam splitter 122L is arranged below the left-eye display element 101L (in the −Y direction) in a tilted manner. The display light PL11 from the left-eye display element 101L enters the beam splitter 122L. The beam splitter 122L reflects a part of the display light PL11 toward the combiner 121L. The remaining display light PL11 transmitted through the beam splitter 122L is absorbed by the light-shielding unit 130L.

The display light PL11 reflected by the beam splitter 122L is reflected forward (in the +Z direction). The display light PL11 then enters the combiner 121L. The combiner 121L reflects a part of the display light PL11 backward (in the −Z direction). Here, the display light PL11 reflected by the combiner 121L is referred to as the display light PL12. Since the combiner 121L is a concave mirror, an optical path of the reflected display light PL12 converges toward the left eye EL. The display light PL12 reflected by the combiner 121L enters the beam splitter 122L. The beam splitter 122L transmits a part of the display light PL12.

The display light PL12, which has been transmitted through the beam splitter 122L, enters the left eye EL. As described above, the left-eye optical system 103L guides the display light PL11 from the left-eye display element 101L to the left eye EL of the user. This optical system enables the head-mounted display 100 to display a virtual image in front of the user (in the +Z direction). Since a concave mirror is used as the combiner 121L, a display image is enlarged and displayed.

Next, the external light PL21 which is visually recognized as the external scene in front of the user (in the +Z direction), will be described below. A prat of the external light PL21 is transmitted through the combiner 121L. The external light PL21, which has been transmitted through the combiner 121L, enters the beam splitter 122L. The beam splitter 122L transmits a part of the external light PL21. The external light PL21, which has been transmitted through the beam splitter 122L, enters the left eye EL.

Since the head-mounted display 100 is a semi-transmissive type, the combiner 121L combines the external scene, which is the external light PL21 transmitted through the combiner 121L from the front (+Z direction), with the display light PL11 from the left-eye display element 101L. By providing the combiner 121L in front of the user (+Z direction), the head-mounted display 100 can be an optical see-through system. A display image is superimposed on scenery in front of the user (+Z direction). That is, the user can visually recognize scenery where the display image is superimposed.

In the embodiment, the combiner 121L extends below the lower edge 122L1 of the beam splitter 122L. The combiner 121L extends below the lower edge of the optical path of the display light PL12 which is reflected light of the display light PL11 to be reflected by the beam splitter 122L and to enter the combiner 121L. Thus, the user's field of vision is extended such that the external scene extends below the angle of view θ3 of the display light PL12 (in the −Y direction).

As for the configuration of the light-shielding unit 130L, as described above, the light-shielding unit 130L shields the external light PL71, which is to be transmitted through the combiner 121L, be reflected by the beam splitter 122L, and be directed to the left eye EL. The external light PL71 shielded by the light-shielding unit 130L includes at least: external light PL51 having a predetermined incident angle where the external light PL51 enters the lower edge 121L1 of the combiner 121L; and external light PL61 having a predetermined incident angle where the external light PL61 enters the lower edge 122L1 of the beam splitter 122L positioned at a front side (+Z direction) of the beam splitter 122L. Here, the predetermined incident angle is an incident angle of external light that satisfies a condition of the external light PL71 among external light entering the lower edge 121L1 of the combiner 121L or the lower edge 122L1 of the beam splitter 122L.

As for a specific range of the external light PL71, as illustrated in FIG. 5, a reflection plane of the beam splitter 122L is used as a reference plane BSL, and a virtual eyeball position VEL is set at a position that has planar symmetry with the left eye EL with respect to the reference plane BSL. In other words, the external light PL71 shielded is external light passing through the combiner 121L and the beam splitter 122L at an incident angle and an incident position in a range from the external light PL51 to the external light PL61, which intersect at the virtual eyeball position VEL, as illustrated in FIG. 5. The light-shielding unit 130L, particularly the light-shielding plate 131L, is provided to be able to shield the external light PL51 entering the lower edge 121L1 of the combiner 121L at a predetermined incident angle where the external light PL51 can pass through the lower edge 121L1 of the combiner 121L to directly enter the virtual eyeball position VEL. In addition, the light-shielding unit 130L, particularly the light-shielding plate 131L, is provided to be able to shield the external light PL61 entering the lower edge 122L1 of the beam splitter 122L at a predetermined incident angle where the external light PL61 can pass through the lower edge 122L1 of the beam splitter 122L to directly enter the virtual eyeball position VEL.

In the light-shielding plate 131L of the light-shielding unit 130L, a projecting length from the lower edge 121L1 of the combiner 121L is set in such a manner that the external light PL71 including the external light PL51 and PL61 can be shielded.

As described above, the head-mounted display 100 according to the embodiment includes the combiner 121L (121R), the beam splitter 122L (122R), and the light-shielding unit 130L (130R). The combiner 121L (121R) is configured to combine the display light PL11 (PR11) for forming a display image with the external scene in front (+Z direction) of the user wearing the head-mounted display 100, and is provided to extend below the lower edge of the optical path of the display light PL11 (PR11), which enters the combiner 121L (121R). The beam splitter 122L (122R) is arranged between the combiner 121L (121R) and the user's left eye EL (right eye ER), reflects the display light PL11 (PR11) toward the combiner 121L (121R), and transmits the display light PL12 (PR12) reflected by the combiner 121L (121R). The light-shielding unit 130L (130R) shields the external light PL71 (PR71), which is to be transmitted through the combiner 121L (121R), be reflected by the beam splitter 122L (122R), and be directed toward the user's left eye EL (right eye ER).

The light-shielding unit 130L (130R) may be the light-shielding plate 131L (131R) which projects forward (in the +Z direction) of the user from the lower edge 121L1 (121R1) of the combiner 121L (121R).

The head-mounted display 100 may be configured in such a manner that the light-shielding unit 130L (130R) shields, as the external light PL71 (PR71), at least: external light entering at an angle where the external light is to be transmitted through the lower edge 121L1 (121R1) of the combiner 121L (121R), be reflected by the beam splitter 122L (122R), and be directed toward the user's left eye EL (right eye ER); and external light entering at an angle where the external light is to be reflected by the lower edge 122L1 (122R1) of the beam splitter 122L (122R) and be directed toward the user's left eye EL (right eye ER).

### Other Modified Example

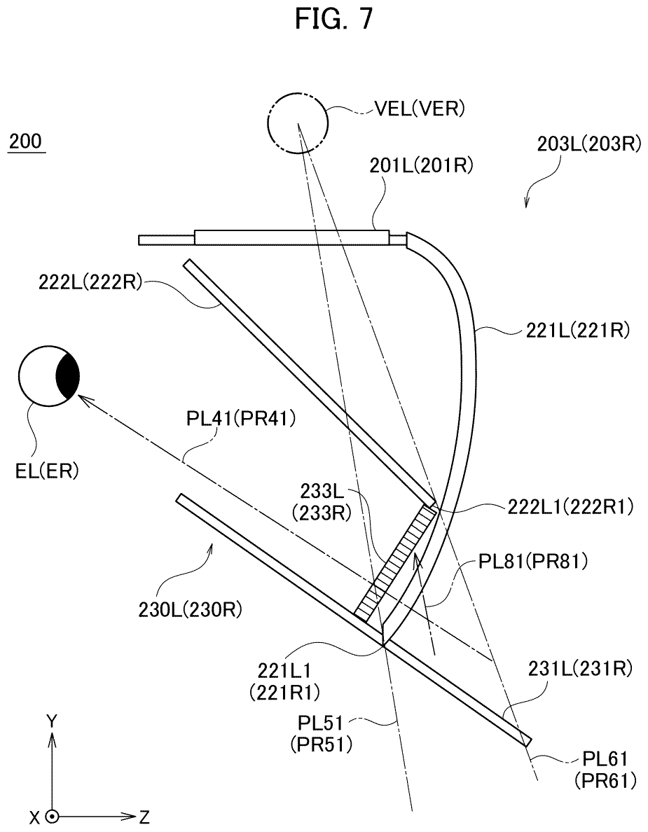

A head-mounted display 200 according to a second modified example illustrated in FIG. 7 has the same configuration as the head-mounted display 100 according to the above-described embodiment, except that a light-shielding unit 230L includes a louver film 233L (233R). Here, the louver film has a configuration where plate-like opaque portions are regularly arranged in a transparent film, and can control light passage directions.

That is, as illustrated in FIG. 7, the head-mounted display 200 according to the second modified example includes a combiner 221L, a beam splitter 222L, and a light-shielding unit 230L. The combiner 221L is configured to combine the display light PL11 for forming a display image with external scenes (external light PL21 and PL41) in front (+Z direction) of the user wearing the head-mounted display 200, and extends below a lower edge of the optical path of the display light PL11, which enters the combiner 221L. The beam splitter 222L is arranged between the combiner 221L and the user's left eye EL, reflects the display light PL11 toward the combiner 221L, and transmits the display light PL12 reflected by the combiner 221L. The light-shielding unit 230L shields external light PL71 and PL81, which is to be transmitted through the combiner 221L, be reflected by the beam splitter 222L, and be directed toward the user's left eye EL. Note that in FIG. 7, the display light PL11, the external light PL21, the external light PL71, and the like, which are similar to those in FIG. 4, are not illustrated.

As illustrated in FIG. 7, the louver film 233L (233R) included in the light-shielding unit 230L of the head-mounted display 200 according to the second modified example is arranged below a lower edge 222L1 of the beam splitter 222L. The louver film 233L is a film whose viewing angle is limited such that the external scene (external light PL21 and PL41) is transmitted and the external light PL71 and PL81 is shielded. Note that the light-shielding unit 230L may be arranged between the lower edge 222L1 of the beam splitter 222L and a lower edge 221L1 of the combiner 221L in the front-back direction (Z direction) as illustrated in FIG. 7.

Note that in the head-mounted display 200 according to the second modified example, the light-shielding unit 230L may be a light-shielding plate 231L projecting forward (in the +Z direction) of the user from the lower edge 221L1 of the combiner 221L. In this configuration, the light-shielding plate 231L can effectively shield the external light PL71.

Further, in the second modified example, the light-shielding unit 230L is arranged below the lower edge 222L1 of the beam splitter 222L, and has the louver film 233L (233R), which transmits the external scene (external light PL41) and shields the external light PL71 and PL81.

In the second modified example, even when, for example, strong light enters an upper (+Y side) surface of the light-shielding plate 231L, and scattered light is transmitted through the combiner 221L as the external light PL81, the scattered light (external light PL81) is shielded by the louver film 233L before entering the beam splitter 222L. In addition, the louver film 233L may shield not only the scattered light (external light PL81), but also the external light PL71 even when the light-shielding plate 231L is not provided.

In the head-mounted display 200, the light-shielding unit 230L may be configured to shield, as the external light PL71 and PL81, at least: external light entering at an angle where the external light is to be transmitted through the lower edge 221L1 of the combiner 221L, be reflected by the beam splitter 222L, and be directed toward the user's left eye EL; and external light entering at an angle where the external light is to be reflected by the lower edge 222L1 of the beam splitter 222L, and be directed toward the user's left eye EL.

Note that in the second modified example, the light-shielding unit 230L includes the light-shielding plate 231L and the louver film 233L. However, in a configuration to which the louver film 233L is provided, the light-shielding plate 231L may be omitted.

The light-shielding unit 230L having the louver film 233L in the second modified example is also applicable to the first modified example described above where the structure of the combiner is modified. In this case, the louver film 233L is arranged below the lower edge 222L1 of the beam splitter 222L.

Although the invention made by the present inventor has been specifically described above on the basis of the embodiment, it is needless to say that the present invention is not limited to the above-described embodiment, and various modifications may be made without departing from the gist thereof. The above-described embodiment and the above-described first and second modified examples can be suitably combined.

What is claimed is:

1. A head-mounted display, comprising:
a combiner configured to combine display light with an external scene in front of a user wearing the head-mounted display, and provided to extend below a lower edge of an optical path of the display light entering the combiner; and
a beam splitter arranged between the combiner and an eye of the user, and configured to reflect the display light toward the combiner, and to transmit the display light reflected by the combiner; and
a light-shielding unit configured to shield external light that is to be transmitted through the combiner, be reflected by the beam splitter, and be directed toward the eye of the user.

2. The head-mounted display according to claim 1, wherein the light-shielding unit includes a light-shielding plate projecting from a lower edge of the combiner in a direction away from the user.

3. The head-mounted display according to claim 2, wherein a field of vision of the user includes a first visual field region visually recognized by the user through the combiner, and
the light-shielding plate is arranged not to enter the first visual field region.

4. The head-mounted display according to claim 1, wherein the light-shielding unit is configured to shield, as the external light, at least: external light entering at an angle where the external light is to be transmitted through a lower edge of the combiner, be reflected by the beam splitter, and be directed toward the user's eye; and external light entering at an angle where the external light is to be reflected by a lower edge of the beam splitter positioned at a front side of the beam splitter, and be directed toward the eye of the user.

5. The head-mounted display according to claim 1, wherein the light-shielding unit includes a louver film that is arranged below a lower edge of the beam splitter and is configured to transmit the external scene and to shield the external light.

6. A head-mounted display, comprising:
a combiner configured to combine display light with an external scene in front of a user wearing the head-mounted display;
a beam splitter arranged between the combiner and an eye of the user, and configured to reflect the display light toward the combiner, and to transmit the display light reflected by the combiner; and
a light-shielding unit, wherein
a field of vision of the user includes: a first visual field region that is visually recognized by the user through the combiner; and a second visual field region that is visually recognized, as a field of vision continuing to a lower side of the first visual field region, without passing through the combiner and with passing below the combiner, and
the light-shielding unit shields external light that is to enter from below the second visual field region, be reflected by the beam splitter, and be directed toward the eye of the user.

7. The head-mounted display according to claim 6, wherein the light-shielding unit includes a light shielding plate that projects from below a lower edge of the combiner in a direction away from the user.

8. The head-mounted display according to claim 7, wherein the light-shielding plate is arranged not to enter the first visual field region and the second visual field region.

9. The head-mounted display according to claim 6, wherein the light-shielding unit includes a louver film that is arranged below a lower edge of the beam splitter and is configured to transmit the external scene and to shield the external light.
